(19) United States
(12) Patent Application Publication
(10) Pub. No.: US 2010/0145005 A1
(43) Pub. Date: Jun. 10, 2010

(54) METHOD AND APPARATUS FOR DENSIFYING POLYPROPYLENE

(75) Inventors: Jack E. Hitzler, Allegan, MI (US); James Scobey, Hopkins, MI (US); Brent H. Sebright, Hopkins, MI (US)

Correspondence Address: MCGARRY BAIR PC, 32 Market Ave. SW, SUITE 500, GRAND RAPIDS, MI, 49503, US

(73) Assignee: SEBRIGHT PRODUCTS, INC., Hopkins, MI (US)

(21) Appl. No.: 12/327,829

(22) Filed: Dec. 4, 2008

(51) Int. Cl. C08F 6/00; B01J 19/00

(52) U.S. Cl. 528/502 C; 422/309

(57) ABSTRACT

A method of densifying polypropylene includes steps of reducing expanded polypropylene into relatively small particles and heating and compressing the particles to form densified polypropylene. The expanded polypropylene can be reduced to intermediate pieces prior to reduction to the small particles. The combination of the particle size, heat, and compression effects lasting densification of the polypropylene. An apparatus for densifying polypropylene includes a grinder to generate particles of expanded polypropylene and a densifier that heats and compresses the particles into densified polypropylene.

### CROSS REFERENCE TO RELATED APPLICATIONS

This application claims priority on U.S. Provisional Patent Application No. 60/991,938, filed Dec. 3, 2007, incorporated herein by reference.

### BACKGROUND OF THE INVENTION

1. Field of the Invention

The invention relates to a method and apparatus for densifying polypropylene.

2. Description of the Related Art

It is known to process expanded polystyrene (Styrofoam) by placing the expanded polystyrene into a pre-breaker, which grounds the expanded polystyrene into pieces sized approximately 1 to 2 inches, and then compressing the pieces in a densifier. The densifier comprises a hopper that receives the pieces from the pre-breaker, a force feeder that compresses the pieces into the hopper, and a densifying chamber where a ram deck compresses the pieces against a platen in an exiting plenum to form a densified brick or log. For expanded polystyrene, the ram typically operates with a hydraulic pressure of about 2300 psi, and the platen reacts with a hydraulic pressure of about 1800 psi. The resulting logs are shipped to processors who can use the material, along with virgin polystyrene, to make more Styrofoam.

Expanded polypropylene is typically used for packing automobile and truck parts for shipment. Principal reasons for using expanded polypropylene include minimal static electricity and better cushioning than other materials, such as expanded polystyrene. However, expanded polypropylene is not easily processed like expanded polystyrene and, thus, is typically disposed of in landfills rather than recycled. Federal grants and incentives are provided in an attempt to keep expanded polypropylene out of landfills, and makers of expanded polypropylene now recycle used expanded polypropylene with virgin polypropylene to make polypropylene products. But it is not cost effective to transport expanded polypropylene to recyclers because of its light weight. A semi-trailer full of expanded polypropylene carries a load of about 3000 to 5000 pounds, but a semi-trailer needs to carry a load of about 35,000 to 40,000 pounds to be cost effective. Consequently, users of expanded polypropylene have opted to store used expanded polypropylene in warehouses rather than transport it to recyclers.

Expanded polypropylene must be densified to render transportation of the material cost effective. Prior attempts to densify expanded polypropylene have been unsuccessful. The material has a much stronger memory then expanded polystyrene, for example, and running expanded polypropylene through the Styrofoam densifying process results in logs that fall apart and grow in size after densification.

### SUMMARY OF THE INVENTION

A method of densifying polypropylene according to one embodiment of the invention comprises reducing expanded polypropylene into relatively small particles and heating and compressing the particles to form densified polypropylene. The expanded polypropylene can be reduced to the small particles by grinding. The expanded polypropylene can be reduced to intermediate pieces prior to reduction to the small particles. The expanded polypropylene can be reduced to the intermediate pieces by pre-breaking. During the heating of the particles, heat can be applied to increase the temperature of the polypropylene to a temperature below the melting temperature of polypropylene yet sufficiently high to weaken the polypropylene bonds and overcome the memory of the material.

An apparatus for densifying polypropylene according to one embodiment of the invention comprises a grinder for reducing expanded polypropylene into relatively small particles and a densifier for heating and compressing the particles to form densified polypropylene. The apparatus can further comprise a pre-breaker to reduce the expanded polypropylene into intermediate pieces prior to being reduced to the small particles by the grinder. The densifier can comprise a ram and platen system that compresses the particles in a densification chamber and a heater that heats the densification chamber and, thereby, the polypropylene in the densification chamber. The apparatus can further include a hopper that collects the particles from the grinder and gravity feeds the particles into the densifier.

### BRIEF DESCRIPTION OF THE DRAWINGS

In the drawings:

FIG. 1 is a flow chart of a method of densifying polypropylene according to one embodiment of the invention.

FIG. 1A is a flow chart of a method of densifying polypropylene according to another embodiment of the invention.

FIGS. 2A and 2B are a schematic view of an apparatus for densifying polypropylene according to one embodiment of the invention.

FIG. 3 is a schematic view of a portion of an apparatus for densifying polypropylene according to another embodiment of the invention.

### DESCRIPTION OF EMBODIMENTS OF THE INVENTION

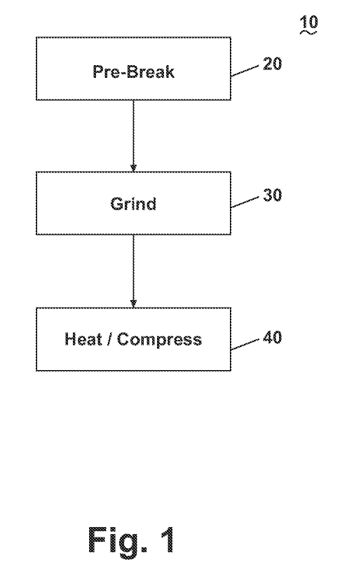

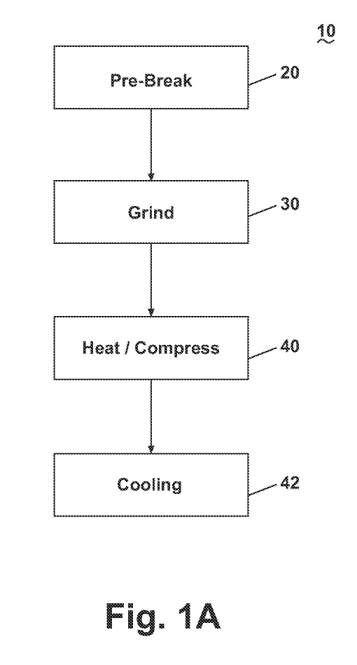

Referring now to the drawings, FIG. 1 provides a flow chart illustrating a method 10 according to one embodiment of the invention for densifying polypropylene. The method 10 converts expanded polypropylene into densified polypropylene. The densified polypropylene has a density greater than that of the expanded polypropylene. As a result of the densification method 10, a given volume of the polypropylene contains more material and weighs more than the same volume prior to the densification method 10, thereby improving the cost effectiveness of transporting the polypropylene for reuse.

According to the illustrated embodiment, the method 10 begins with a pre-break step 20 during which expanded polypropylene parts are broken into smaller pieces. The parts can have any suitable initial size and can be broken into any suitable size smaller than the initial size. For example, the parts can be broken into pieces on the order of about 1 to 2 inches. The parts can be broken into the pieces in any desirable manner, and the pre-break step 20 can be similar to the pre-breaking described above in the background section and known for the densification of polystyrene. The pre-breaking of the parts can employ mechanical and/or chemical means for breaking the expanded polypropylene parts.

The pieces of expanded polypropylene resulting from the pre-break step 20 are then further reduced into smaller particles during a grind step 30. The pieces can be ground or otherwise reduced to any suitable particle size smaller than the size of the pieces, and an exemplary range of sizes for the particles is from about ¼ to ⅜ inches. The pieces can be reduced to the particles in any desirable manner, such as by grinding the pieces, during the grind step 30. The grinding of the pieces into the particles can employ mechanical and/or chemical means for reducing the size of the expanded polypropylene pieces.

The particles of expanded polypropylene resulting from the grind step 30 are then formed into a brick of densified polypropylene during a heat and compress step 40. During the heat and compress step 40, a plurality of the particles are compressed together, thereby reducing and possibly eliminating space between and within the particles. During the compression of the particles, heat provided to particles heats the polypropylene to a temperature less than its melting temperature yet sufficiently high to weaken or otherwise affect the polypropylene bonds and maintain the densified condition. It is also within the scope of the invention to supply heat to the particles before and/or after the compression of the particles in lieu of or in addition to during the compression of the particles. The combination of the particle size, the compression, and the heat enables a lasting densification of polypropylene that overcomes the “memory” of the expanded polypropylene. The heat and compress step 40 results in a mass or brick of densified polypropylene having a density significantly greater than that of the expanded polypropylene prior to the densification method 10.

Looking now at FIG. 1A, an alternate embodiment accommodates those times when the edges of a densified polypropylene brick tend to curl after the heating/compressing step. It has been found that in some circumstances the outside edges of a brick tend to curl outwardly upon exiting the apparatus when the pressure is relieved. According to this alternate embodiment, a cooling step is added where some cooling of the polypropylene occurs after heating but while it still compressed before pressure is relieved. Such cooling acts to minimize the tendency of the outside edges of a brick to curl outwardly upon relief from the pressure of the densification.

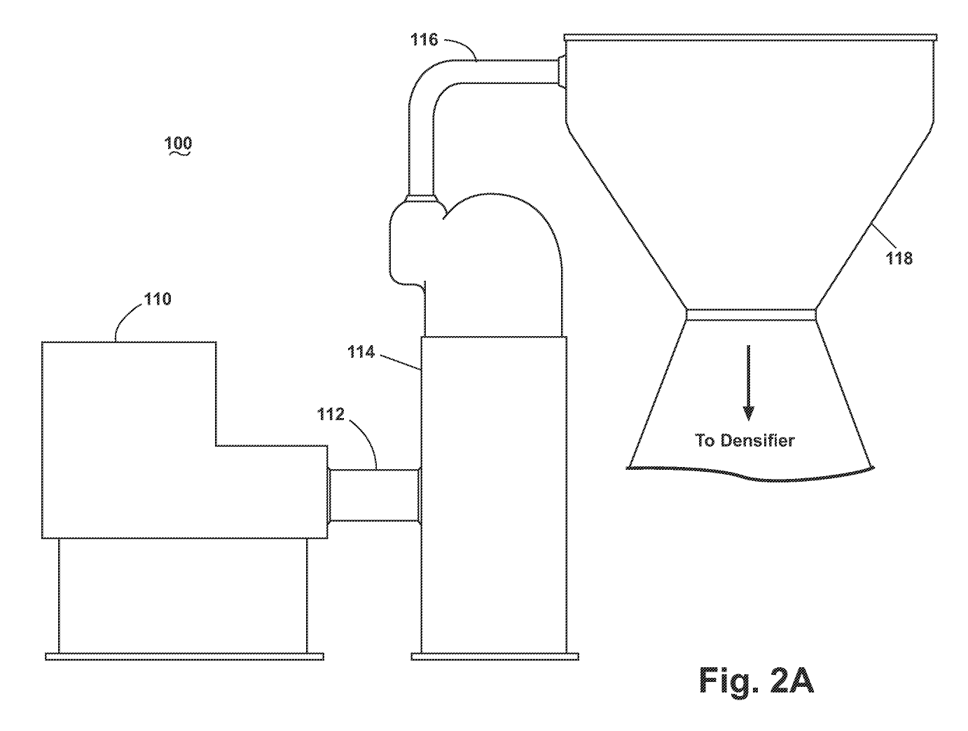

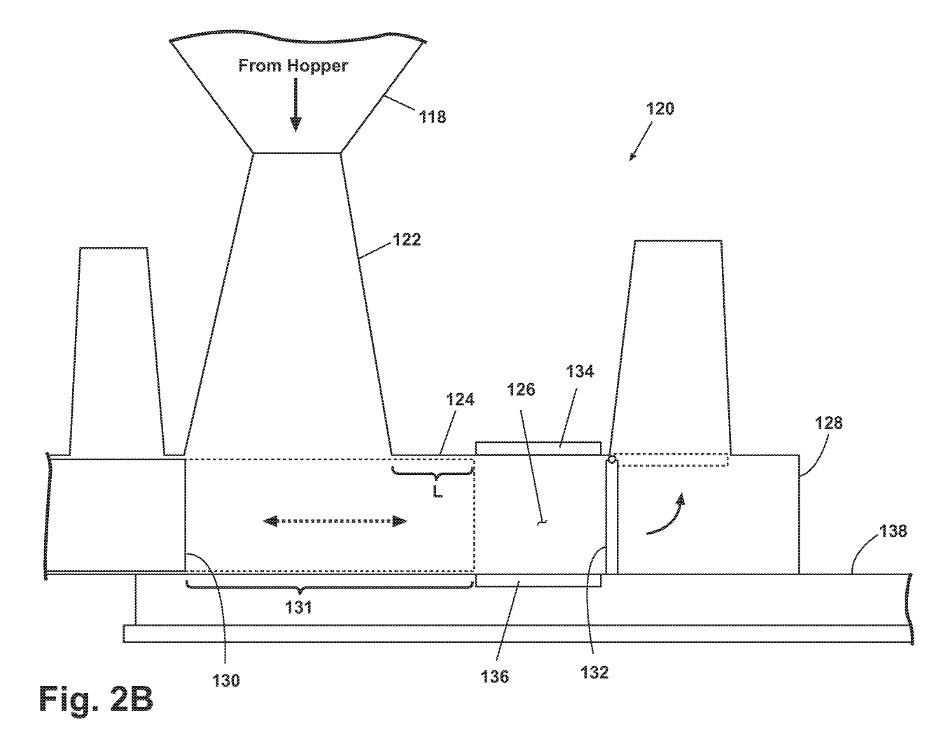

FIGS. 2A and 2B are schematic views of an exemplary apparatus 100 according to one embodiment of the invention for implementing the method 10 of densifying polypropylene. Referring to FIG. 2A, the apparatus 100 includes a pre-breaker 110 that implements the pre-break step 20. The pre-breaker 110 can be any device for breaking the expanded polypropylene parts into pieces of expanded polypropylene, including pre-breakers known for pre-breaking expanded polystyrene parts. The resulting pieces of expanded polypropylene are fed from the pre-breaker 110 through a piece conduit 112 to a grinder 114 that implements the grind step 30. The grinder 114 can be any device for reducing the expanded polypropylene pieces into particles of expanded polypropylene. In one embodiment, the grinder 114 can utilize knives in a hammer mill; other types of known grinders are within the scope of the invention. The resulting particles of expanded polypropylene are output from the grinder 114 through a particle conduit 116 that delivers the particles to a hopper 118, which collects and feeds the particles to a densifier 120. The particle conduit 116 can have any suitable configuration and is illustrated, by example, as extending upward from the grinder 114, in which case, the grinder 114 can include a blower, fan, or other suitable device for directing the particles upward into the particle conduit 116 and to the hopper 118. In the illustrated embodiment, the particle conduit 116 is configured to extend upwardly from the grinder 114 so that the hopper 118 can be located above the densifier 120 and, thereby, feed the particles into the densifier 120 by gravity. Other configurations of the particle conduit 116 and the hopper 118 are within the scope of the invention. The hopper 118 can be any receptacle for receiving the particles and feeding the particles into the densifier 120. As an example, the hopper 118 can be a bag, which can be made of a lightweight material to facilitate suspension of the hopper 118 above the densifier 120.

Now referring to FIG. 2B, the densifier 120 receives the particles from the hopper 118 and implements the heat/compress step 40. The densifier 120 includes a densifier hopper 122 aligned with a bottom opening of the hopper 118 for receiving the particles therefrom. The weight of the particles fed to the densification hopper 122 is sufficient to force the particles to the bottom of the densifier hopper 118 where they are positioned for entry into a densification chamber 126 formed by a plurality of densification chamber walls 124 and having an outlet 128. Optionally, the densification hopper 118 can incorporate a force feeder to assist the gravity feed and force the expanded polypropylene particles to the bottom of the densification hopper. Any suitable force feeder can be incorporated into the densification hopper 118, including a known force feeder for use in densifying expanded polystyrene. The force feeder can be operated at any desired force, such as at full force or a reduced force less than the full force. In one embodiment, the full force is delivered with a hydraulic pressure of about 1800 psi, and an exemplary reduced hydraulic pressure is about 1100 psi. The full force and reduced force are machine dependent variables and affect the amount of expanded polypropylene particles positioned for entry into the densification chamber 126. The densification chamber 126 can have any suitable shape and size and can be formed by walls of any suitable thickness and material. As one example, the densification chamber 126 can be generally rectangular or square in transverse cross-section (i.e., transverse to the direction of polypropylene movement in the densification chamber 126) and formed by the densification chamber walls 124 made of steel, such as ¾ inch thick steel.

A reciprocally movable ram 130 pushes the particles at the bottom of the densification hopper 122 into the densification chamber 126, and a movable platen 132 at or near the end of the densification chamber 126 applies backside pressure to the particles. The ram 130 is movable between a first position where the particles are able to fall to the bottom of the densification hopper 122 in alignment with the densification chamber 126, as shown by example as the solid line ram 130 in FIG. 2B, and a second position within the densification chamber 126, as shown by example in dotted lines in FIG. 2B. The extreme positions of the ram 130 define a stroke 131 of the ram 130, and the stroke 131 can be adjusted according to the dimensions and other specifications of the densifier 120. In one embodiment, the ram 130 can extend a distance L (here, approximately 22 inches) into the densification chamber 126 past the bottom of the densification hopper 122. The platen 132 can be configured to move, such as by pivoting, from a first position, such as generally vertical position, as shown by example as the solid line platen 132 in FIG. 2B, to a second position, such as a generally horizontal position, as shown by example by the dotted lines FIG. 2B, as the forming brick of densified polypropylene moves past the platen 132 and out of the densification chamber 126. As the brick moves past the platen 132, the platen 132 continues to apply pressure to an upper side of the brick, and this downward pressure in combination with upward resistance force applied from the bottom wall of the densification chamber 126 and the pressure applied by the ram 130 causes compression of the polypropylene, even as the forming brick moves past the platen 132. In one embodiment, the hydraulic pressure delivered to the ram 130 is greater than about 2000 psi, and an exemplary pressure within this range is about 2300 psi. Exemplary dimensions would include a ram face 30×13 inches with two 7″ bore hydraulic cylinders, calculated to deliver an actual force to the material in the densification chamber at about 450 psi. In one embodiment, the hydraulic pressure applied by the platen 132 is likewise greater than about 2000 psi, and an exemplary pressure within this range is about 2300 psi. Exemplary dimensions would include a platen face 30×35 inches with a single 7″ bore hydraulic cylinder, estimated to deliver an actual force to the material in the densification chamber at about 80 psi. In one embodiment, the hydraulic pressure applied by a force feeder is likewise greater than about 1100 psi, and an exemplary pressure within this range is about 1800 psi. Exemplary dimensions would include a force feeder face 30×40 inches with a single 4″ bore hydraulic cylinder, estimated to deliver an actual force to the material in the hopper at about 18 psi. The foregoing pressures depend on, among other factors, the size and shape of the densification chamber 126 and the hopper 122.

The platen 132 can have any suitable configuration and be mounted in any desirable manner in the densifier 120. For example, the pivot point of the platen 132 can be positioned for a desired pivoting direction. In other words, the platen 132 can pivot in directions other than upwards, such as downwards or sideways, depending on the location of the platen 132 relative to the densification chamber 126. Further, the platen 132 need not pivot but can be configured to move in other manners to accommodate the brick as it moves past the platen 132.

The densifier 120 further includes a heater to add heat to the particles and the forming brick of densified polypropylene in the densification chamber 126. The heat applied to the densification chamber 126 increases the temperature of the polypropylene to a temperature less than its melting temperature to avoid melting of the material but sufficiently high to weaken the polypropylene bonds and overcome the “memory” of the material. The heater can maintain the temperature of the polypropylene within a desired temperature range to achieve the desired densification performance. The heat can be applied to the densification chamber 126 continuously and/or intermittently. Alternatively, heat can be applied to the material directly, either in the densification chamber or before entry into the densification chamber. Preferably, the material will be heated to a temperature 150 to 400 degrees F.

In the illustrated embodiment, the heater is positioned exteriorly of the densification chamber 126 and is in the form of an upper heater 134 located on the upper wall of the densification chamber 126 and a lower heater 136 located on the lower wall of the densification chamber 126. The upper and lower heaters 134, 136 can be located in any suitable position along the densification chamber 126, and as an example, the upper and lower heaters 134, 136 can be located downstream of the maximum extension of the ram 130. The heaters can be any suitable type of heaters, and an exemplary heater is a resistive heater, such as a tube heater encased in a sleeve. In one embodiment, the heaters can comprise six 1000 watt tube heaters, three in the upper heater 134 and three in the lower heater 136. The upper and lower heaters 134, 136 can be controlled to maintain the temperature of the polypropylene at a desired temperature or within a desired temperature range, which can be indirectly measured by monitoring a temperature representative of the polypropylene temperature, such as the temperature at the interface between the upper and lower heaters 134, 136 and the densification chamber walls 124. In the example with about ¾ inch steel densification chamber walls 124, the upper and lower heaters 134, 136 can each be controlled to maintain the interface temperature between about 300° F. and 325° F. Within this range, an exemplary interface temperature is about 325° F. The six 1000 watt heaters can each be run at about 300 W to achieve the desired interface temperature.

The densifier 120 can employ any number, type, and configuration of heater to heat the polypropylene in the densification chamber 126. The actual number, type, and configuration of a heater or heaters will depend on several factors, including the shape and size of the densification chamber, the particular composition of the polypropylene, and the material type and thickness of the densification chamber walls 124. These factors, and others, affect the heat conduction to and through the polypropylene, and it is ultimately the temperature of the polypropylene that is important to control within the preferred range. As stated above, the preferred temperature range is at a lower end sufficiently high to overcome the “memory” of the material, but at a higher end less than the melting temperature of the material to be densified. Further, the heater can be additionally or alternatively located interiorly of the densification chamber walls 124 and/or within the densification chamber walls 124.

Due to the combination of particle size achieved by the grinder 114 and the heat and compression applied by the densifier 120, the apparatus 100 converts the expanded polypropylene into a brick of densified polypropylene that retains its densified state. The brick is formed by a plurality of brick sections, with each brick section being formed during a stroke of the ram 130. The length of each brick section depends in part on the amount of the expanded polypropylene positioned for entry into the densification chamber 126, which, in turn, depends at least in part on whether the force feeder is employed and the force applied by the force feeder. A greater force applied by the force feeder translates into a longer brick section formed by the stroke of the ram 130. In one embodiment, using the force feeder at about 1100 pounds results in a brick section having a length of about 3 inches.

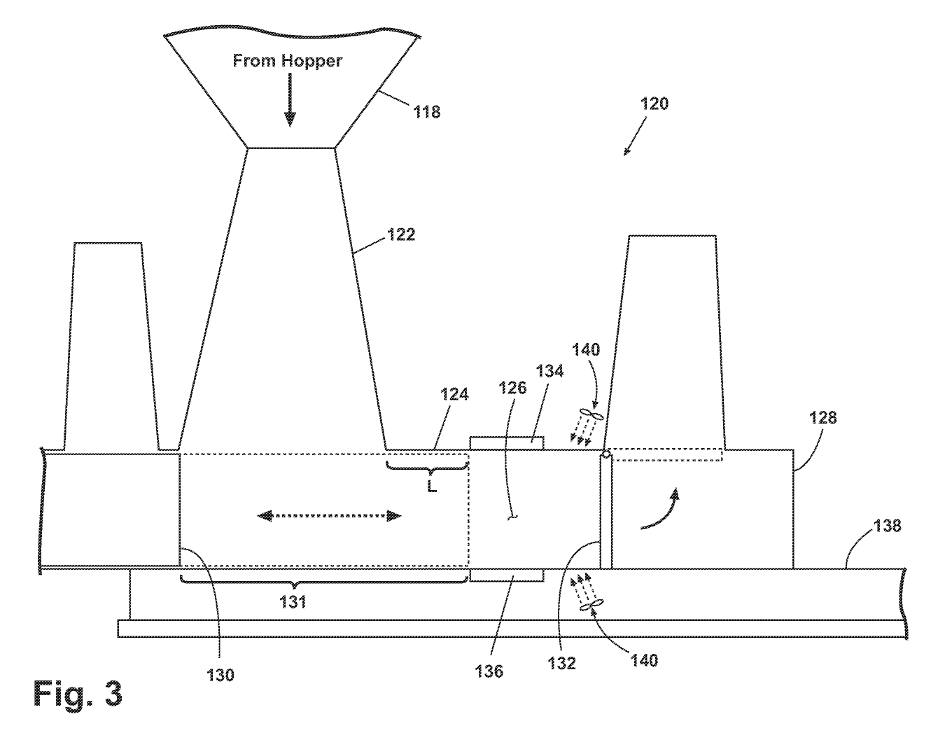

FIG. 3 shows an alternate embodiment of an apparatus similar to that of FIG. 2B, except that it will accommodate the alternate method of FIG. 1B. Elements of FIG. 3 that are substantially the same as those elements in FIG. 2B bear like references. It is to be noted in FIG. 3 that downstream of the heaters 134, 136 is a cooling apparatus 140 that cools the densification chamber 126, and consequently the outside edges of the polypropylene brick moving therein. Cooling can be caused by any of a number of well known structures, but it has been found that utilizing fans to blow air on the outside of the densification chamber 126 downstream of the heaters 134, 136 acts to maintain the cohesiveness of the brick upon exiting the chamber.

The brick exits the densifier 120 through the densification chamber outlet 128, and a conveyor 138 moves the brick, which can be trimmed, such as by manual removal of a length of brick or by a trimming device, to a desired brick length, to a desired location. Optionally, a trimmed brick length, such as a trimmed brick length about 12-14 inches long, can be banded together to ensure that the multiple brick sections forming the brick length do not separate from each other. Separation of the brick sections due to expansion of the densified polypropylene at joints between adjacent brick sections can be avoided by adjusting operational parameters of the densifier 120 so that the material remains under pressure in the densification 126 for a longer time, thereby completely or nearly completely destroying the memory of the material. In one embodiment, a rate of about 300 pounds per hour of material through the densifier 120 results in a brick length that does not require banding, while a faster rate of about 600 pounds per hour results in a brick length for which banding will help retain the brick sections together. While several parameters can be adjusted to vary the rate of the material through the densifier 120, in one embodiment, the use and force of the force feeder can be adjusted to increase or decrease the rate of the material through the densifier 120. In one example, a skid or pallet of the brick of densified polypropylene weighs about 1500 pounds, which is about ten times more than a skid or pallet of expanded polypropylene.

While the exemplary embodiment of the apparatus 100 has been shown and described as having a single pre-breaker 110, a single grinder 114, and a single densifier 120, it is contemplated to employ more than one of any of these devices to achieve a maximum efficiency of the apparatus 100. For example, two of the grinders 114 can be used to keep pace with the output of the pre-breaker 110, and the piece conduit 112 can be adapted to accommodate such a configuration by branching into two outlets, as in a manifold, with each outlet coupling with one of the grinders 114.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method of densifying polypropylene comprising:
reducing expanded polypropylene material into small particles,
compressing the small particles, and
heating the compressed small articles to a temperature sufficiently high to overcome the “memory” of the polypropylene material, but less than the melting temperature of the polypropylene material.

2. The method of claim 1 wherein reducing step comprises grinding the polypropylene material into particles generally sized between ¼ and ⅜ inches.

3. The method of claim 1 wherein reducing step comprises breaking the polypropylene material into pieces generally sized between 1 and 2 inches.

4. The method of claim 1 further comprising the step of cooling the compressed small articles after the heating step.

5. An apparatus for densifying polypropylene comprising a grinder reducing expanded polypropylene material into small particles and a densifier, wherein the densifier has a densification chamber for compressing the small particles and a heater for heating the small particles while under compression.

6. The apparatus of claim 5 further comprising a pre-breaker for reducing the expanded polypropylene material into intermediate sized pieces before they enter the grinder.

7. The apparatus of claim 5 further comprising a ram and a platen that compress the small particles in the densification chamber.

8. The apparatus of claim 5 wherein the heater is disposed to heat the densification chamber.

9. The apparatus of claim 5 further comprising a hopper that collects the particles from the grinder and gravity feeds the particles into the densifier.
